(19) United States
(12) Patent Application Publication
(10) Pub. No.: US 2010/0163717 A1
(43) Pub. Date: Jul. 1, 2010

(54) CALIBRATION METHOD FOR CALIBRATING AMBIENT LIGHT SENSOR AND CALIBRATION APPARATUS THEREOF

(76) Inventors: Yaw-Guang Chang, Tainan County (TW); Chun-Yi Wu, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/344,289

(22) Filed: Dec. 26, 2008

(51) Int. Cl. G01D 18/00; G01J 1/10

(52) U.S. Cl. 250/252.1; 356/243.1

(57) ABSTRACT

A calibration method for calibrating an ambient light sensor (ALS) includes: testing the ALS by a plurality of test brightness inputs, and deriving a plurality of test ALS outputs respectively corresponding to the test brightness inputs; converting at least the test ALS outputs from an analog manner into a digital manner to generate a plurality of test ALS output values respectively; storing a test result including at least the test ALS output values; and calibrating a brightness value corresponding to a normal ALS output value according to information stored in the test result, thereby generating a calibrated brightness value.

### BACKGROUND OF THE INVENTION

1. Field of the Invention

The present invention relates to detection of ambient light, and more particularly, to a calibration method for calibrating an ambient light sensor (ALS) and a calibration apparatus thereof to eliminate or alleviate a die-by-die deviation (i.e., process deviation) of the ALS and hence ensure the ALS output under an ambient light environment can be an accurate control signal indicative of the actual ambient light brightness.

2. Description of the Prior Art

Power management for electronic devices, and particularly for portable electronic devices, is an important issue. In the case of portable electronic devices, the power source is usually a battery device with limited energy capacity. Taking an LCD device as an example, the LCD device adjusts the luminance of light output from its backlight module in accordance with the light brightness of the ambient environment to thereby reduce unnecessary power consumption.

An output signal of a conventional ambient light sensor (ALS) serves as a control signal of the backlight brightness of the electronic devices (e.g., LCD devices). Specifically, a driver IC refers to the control signal generated from the ALS for adjusting the backlight brightness in accordance with the ambient light brightness. Under the same ambient environment, however, the die-by-die variation (i.e., process variation) existing in every ALS and non-linear characteristics existing in the ALS output signals leads to control signals outputted from different ambient light sensors typically indicative of different light brightness.

As a result, this makes the backlight modules of LCD devices output different backlight luminance under the same ambient light environment.

### SUMMARY OF THE INVENTION

It is therefore one of the objectives of the present invention to provide a calibration method and a calibration apparatus for calibrating an ambient light sensor (ALS) to thereby calibrate the output signal of the ALS for deriving a calibrated ALS output value indicative of a precise brightness value while the electronic device including the ALS and backlight module is operated under a usage environment.

By the disclosed calibration method, the non-ideal performance of the ALS caused by the said die-by-die process deviation and the non-linear ALS output issue are solved. This ensures that each ALS gets the same absolute light brightness detection result under the same ambient light environment. In this way, each backlight module can receive a correct control signal indicative of the actual ambient light brightness.

An exemplary embodiment of a calibration method for calibrating an ambient light sensor (ALS) includes: testing the ALS by a plurality of test brightness inputs, and deriving a plurality of test ALS outputs respectively corresponding to the test brightness inputs; converting at least the test ALS outputs from an analog manner into a digital manner to generate a plurality of test ALS output values respectively; storing a test result including at least the test ALS output values ; and calibrating a brightness value corresponding to a normal ALS output value according to information stored in the test result, thereby generating a calibrated brightness value.

An exemplary embodiment of a calibration apparatus for calibrating an ambient light sensor (ALS) includes a test device, an analog-to digital converter (ADC), a storage device, and a calibration device. The test device generates a plurality of test brightness inputs to the ALS, wherein the ALS generates a plurality of test ALS outputs in response, respectively, to the test brightness inputs. The ADC converts at least the test ALS outputs from an analog manner into a digital manner to generate a plurality of test ALS output values respectively. The storage device stores a test result including at least the test ALS output values. The calibration device, coupled to the storage device, calibrates a brightness value corresponding to a normal ALS output value according to information stored in the test result, thereby generating a calibrated brightness value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram illustrating a calibration apparatus for calibrating an ambient light sensor according to an exemplary embodiment of the present invention.

FIG. 2 is a diagram illustrating an electronic device including the calibration apparatus and the ambient light sensor according to an exemplary embodiment of the present invention.

FIG. 3 is a diagram illustrating an output signal of the ambient light sensor according to an exemplary embodiment of the present invention.

FIG. 4 is a diagram illustrating a relation between light brightness and the ALS output according to an exemplary embodiment of the present invention.

FIG. 5 is a flowchart illustrating operation of the calibration apparatus shown in FIG. 1 and FIG. 2 for calibrating an ambient light sensor according to an exemplary embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

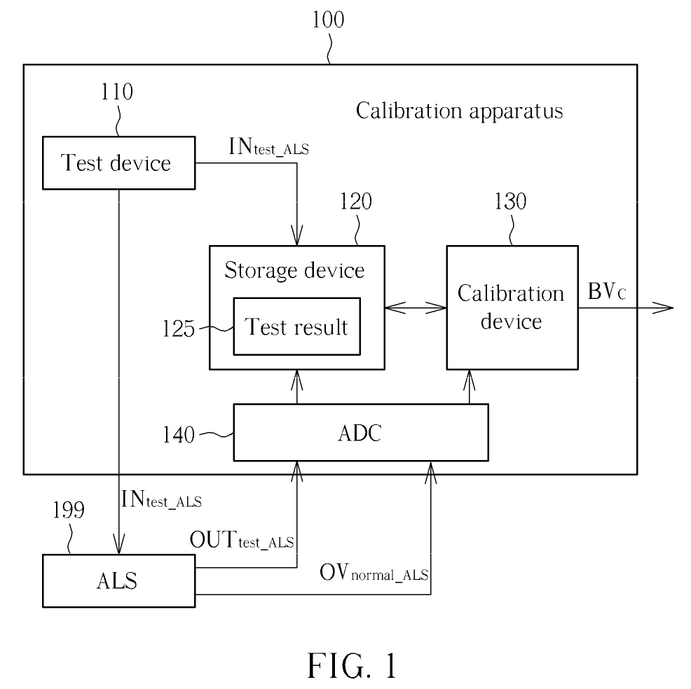

Please refer to FIG. 1. FIG. 1 is a diagram illustrating a calibration apparatus 100 for calibrating an ambient light sensor (ALS) 199 according to an exemplary embodiment of the present invention. As shown in FIG. 1, the calibration apparatus 100 includes (but is not limited to) a test device 110, an ADC 124, a storage device 120, and a calibration device 130.

As shown in FIG. 1, before being shipped to the market, the test device 110 generates a plurality of test brightness inputs IN_{test-ALS}, wherein the test device 110 is used for the testing purposes only and is a removable unit which is removed before an electronic device including the ALS 199 is shipped to the market. Under the testing process before shipped to the market, the ALS 199 generates a plurality of test ALS outputs OUT_{test-ALS} in response to the test brightness inputs IN_{test-ALS}, respectively. In a common case the ADC (analog-to-digital converter) 140 has an analog-to-digital conversion capability for converting analog current values or voltage values (test ALS outputs) corresponding to the detected light brightness into a digital manner (test ALS output values). Under a testing process, the test ALS output values respectively corresponding to the test ALS outputs OUT_{test-ALS} are stored into the storage device 120.

The storage device 120 is used for storing the test brightness inputs IN_{test-ALS} from the test device 110, and storing the ALS output values corresponding to the test ALS outputs OUT_{test-ALS}. In this embodiment, the storage device 120 is implemented using a non-volatile memory, which stores a test result 125 including, for example, the test ALS output values and the test brightness values, where the test ALS output values are digital values corresponding to the test ALS outputs OUT_{test-ALS} respectively, and the test brightness values are digital brightness values corresponding to the test brightness inputs IN_{test-ALS} respectively. However, the aforementioned descriptions are for illustrative purposes only and not meant to be limitations of the present invention, for instance, for the usage efficiency and for economic consideration, the storage device 120 can merely store the ALS outputs value generated under the testing mode before being shipped to the market, the alternative designs obey and fall within the scope of the present invention.

According to an alternative design of this invention, the storage device 120 is a one-time programmable (OTP) memory within a driver IC (not shown), and the calibration apparatus 100 (excluding the test device 110 since it is a test unit using merely under a testing process in the factory) and the ALS 199 are elements within an LCD device (i.e., a device with an LCD display screen). In this way, when a user operates the LCD device (i.e., a usage environment comparing to the testing process), the calibration device 130 calibrates the ALS output (e.g., a normal ALS output value OV_{normal-ALS} derived) to generate a calibrated brightness value BV_{c} indicative of a precise absolute light brightness every time the ALS outputs an electronic signal corresponding to the ambient light brightness. In this way, the backlight module (not shown) of the LCD device can adjust its light brightness in response to the detection result of the ambient light brightness more accurately, since the non-linear issue and the die-by-die deviation of the ALS have been eliminated or alleviated by the calibration apparatus 100 of the present invention. Moreover, in an alternative design, the driver IC of the LCD device includes the storage device 120, the calibration device 130 and a backlight controller (not shown); the aforementioned descriptions fall with the scope of the present invention.

Briefly summarized, the calibration device 130 is implemented for calibrating a brightness value corresponding to a normal ALS output value OV_{normal-ALS} to thereby precisely generate a calibrated brightness value BV_{c} under a usage environment. The calibration device 130 calibrates the brightness value corresponding to the normal ALS output according to the information stored in the test result 125.

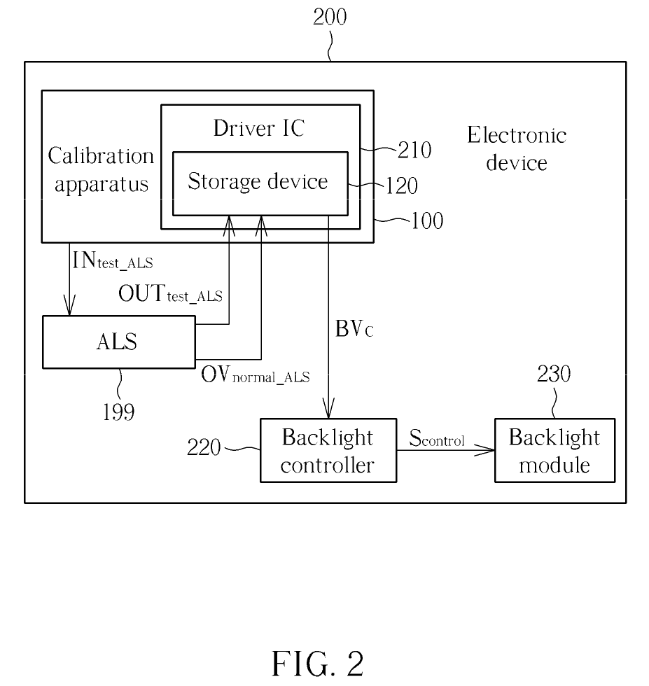

Please refer to FIG. 2 in conjunction with FIG. 1. FIG. 2 is a diagram illustrating an electronic device (e.g., a portable electronic device) 200 according to an exemplary embodiment of the present invention. As shown in FIG. 2, the electronic device (e.g., an LCD device) 200 includes (but not limits to) a storage device 120, a calibration device 130, an ADC 140, an ALS 199, a driver IC 210, a backlight controller 220, and a backlight module 230. That is, the electronic device 200 includes the elements of the calibration apparatus 100 excluding the test device 110. In one implementation, the calibration device 130 shown in FIG. 1 could be integrated into the driver IC 210; however, this is for illustrative purposes only. The calibration device 110 (e.g., the storage device 120 and the calibration device 130) and the backlight controller 220 could be implemented using individual components internal or external to the driver IC 210 according to the design requirements. The same objective of calibrating the ALS output is achieved.

Furthermore, in this embodiment, the storage device 120 is an OTP within the driver IC 210 for storing a test result (e.g., the test result 125 shown in FIG. 1) under a testing process before being shipped to the market. For example, the stored test result 125 includes a plurality of test bright values (e.g., 1 LUX, 100 LUX, 1000 LUX, 65536 LUX, etc.) generated from a test device 100 mentioned above and a plurality of test ALS output values (e.g., 1/W₁, 1/W₁₀₀, 1/W₁₀₀₀, 1/W₆₅₅₃₆, etc.) derived from the analog outputs of the ALS 199.

To put it more concretely, when the electronic device 200 (e.g., a cellular phone with an LCD display) having the calibration apparatus 100 (excluding the test device 110) and the ALS 199 is operated under a usage environment, the backlight brightness of the LCD display in this case is controlled according to the normal ALS output values OV_{normal-ALS}. Under the usage environment, the ALS 199 generates a normal ALS output value OV_{normal-ALS} by monitoring the ambient light brightness. When the ambient light brightness varies, the calibration device 130 calibrates a brightness value according to the normal ALS output value OV_{normal-ALS} and information stored within the test result 125 to thereby generate a calibrated brightness value BV_{c} to reflect the accurate ambient light brightness.

In this way, the electronic device 200 can adjust its backlight brightness more precisely via using the calibration apparatus 100 and the ALS 199 disclosed in the present invention. With the implementation of the calibration apparatus 100 (excluding the test device 110) in different electronic devices 200, each backlight module 230 of the electronic devices 200 under the same ambient light environment will output luminance of light brightness indicative of the same ambient brightness value.

The storage device 120 shown in FIG. 2 could be implemented using a non-volatile memory or a one-time programmable (OTP) memory, depending upon design requirements. In addition, the ALS 199 converts light brightness to analog current values or analog voltage values, and an output of the ALS 199 is generated using a pulse width modulation (PWM) manner, where the PWM width is representative of the detected light brightness. The calibration device 130 shown in FIG. 1 or the driver IC 210 shown in FIG. 2 therefore acknowledges the detected light brightness by measuring the PWM width via the ADC 140, and then stores a digital value corresponding to the measured PWM width into the storage device 120.

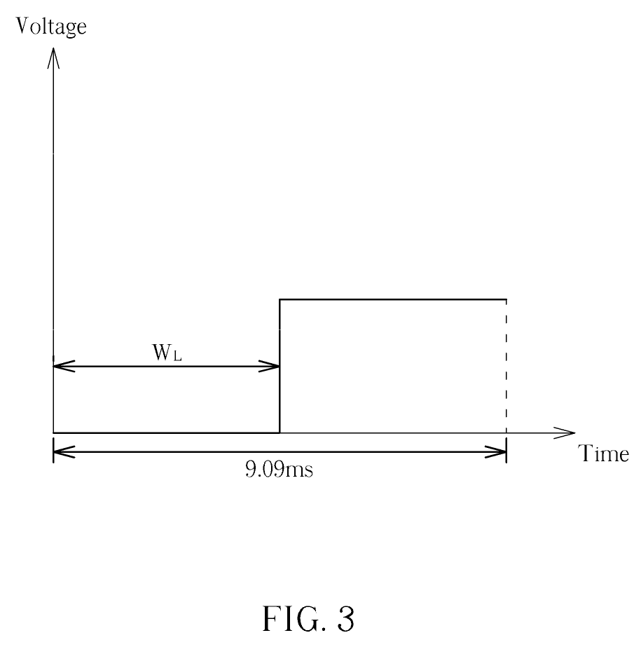

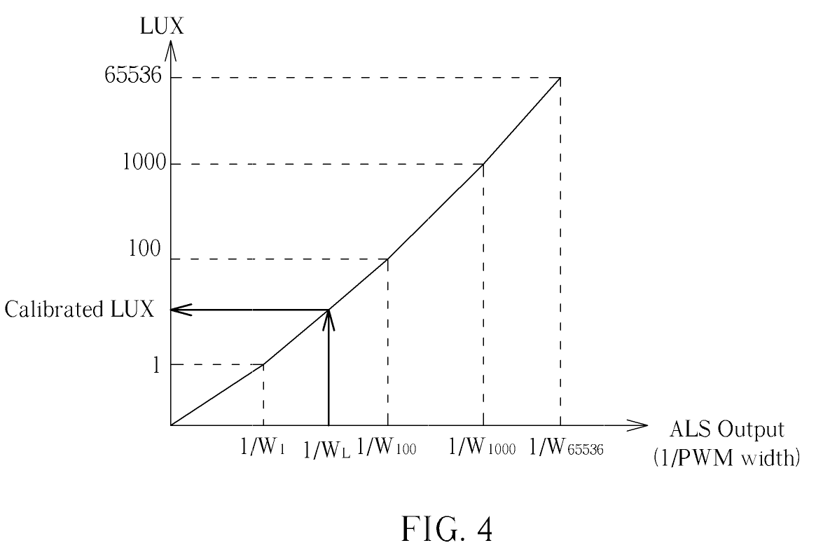

Please refer to FIG. 3 in conjunction with FIG. 4. FIG. 3 is a diagram illustrating an output signal of the ALS 199 in a PWM manner according to an exemplary embodiment of the present invention. FIG. 4 is a diagram illustrating a relation between light brightness (LUX) and corresponding ALS output (1/PWM width) according to an embodiment of the present invention.

As shown in FIG. 3, in this embodiment, every time the ALS 199 receives a certain light brightness, the ALS 199 outputs the corresponding PWN signal shown in FIG. 3, wherein the light brightness is proportional to the reciprocal of the PWM width (i.e., 1/W_{L}); that is, when the light brightness sensed by the ALS 199 has higher luminance, the PWM width W_{L} becomes shorter accordingly. However, FIG. 3 is for illustrative purposes only, for instance, the time magnitude of a period of the PWM signal is not limited to be 9.09 ms, the aforementioned descriptions fall and obey the scope of the present invention.

As shown in FIG. 4, supposing that when an electronic device is being tested, the ALS 199 receives the test signals (such as 1 LUX, 100 LUX, 1000 LUX, etc., from the test device 110), the calibration device 130 derives the PWM widths, such as W₁, W₁₀₀, W₁₀₀₀, etc., corresponding to the test brightness inputs, respectively, and then stores the test ALS output values, such as 1/W₁, 1/W₁₀₀, 1/W₁₀₀₀, etc., into the storage device 120. However, the aforementioned descriptions are for illustrative purposes only, for instance, in other embodiment, the ADC 140 receives the test ALS outputs OUT_{test-ALS} and converting the analog test ALS outputs OUT_{test-ALS} into digital test ALS output values to the storage device 120 directly(as shown in FIG. 1). Furthermore, in the usage environment, the ADC 140 receives the normal ALS output value OV_{normal-ALS} from the ALS 199 and converts the normal ALS output value OV_{normal-ALS} into a digital manner from an analog manner to delivering digital normal ALS output value OV_{normal-ALS} to the calibration device 130. The alternative designs fall within the scope of the present invention.

That is, under the testing process, the storage device 120 stores the test result 125 including information such as the test brightness values (e.g., 1 LUX, 100 LUX, 1000 LUX, etc.), the test ALS output values (e.g., 1/W₁, 1/W₁₀₀, 1/W₁₀₀₀, etc.) and the relation between them. Moreover, the test result 125 can store only the test ALS output values for the economic consideration. Furthermore, the number and the magnitude of the test brightness inputs are adjustable, depending on different design requirements.

As mentioned above, the PWM width W of the output signal of the ALS 199 and the detected light brightness B has the relation

$$\frac{1}{W} ∝ B .$$

When an electronic device is operated under a usage environment, the ALS 199 generates a PWM output signal with a PWM width (e.g., W_{L}) in accordance with the ambient light brightness, and the calibration device 130 accesses the storage device 120 to determine a suitable range among the test ALS output values by referring to the information stored within the test result 125.

For example, a linear interpolation operation is employed to calibrate the normal ALS output value to thereby generate the calibrated brightness value BV_{C}. For clearer understanding, an example is given below.

In the testing process, the storage device 120 stores a plurality of continuous values between the test brightness values and test ALS output values correspondingly (as shown in FIG. 4) in the test result 125. When an electronic device is normally operated, the calibration device 130 executes a linear-interpolation operation to derive the calibrated brightness value (i.e., Calibrated LUX in FIG. 4) according to the normal ALS output value (i.e., 1/W_{L}); that is, the calibration device 130 generates the calibrated brightness value BV_{c} corresponding to the normal ALS output value from the continuous values.

In addition, as shown in FIG. 2, the calibrated brightness value BV_{c} is then utilized as a corresponding control signal S_{control} of the backlight controller 220 for adjusting luminance of a backlight module 230 according to the detected ambient light brightness via the backlight controller 220.

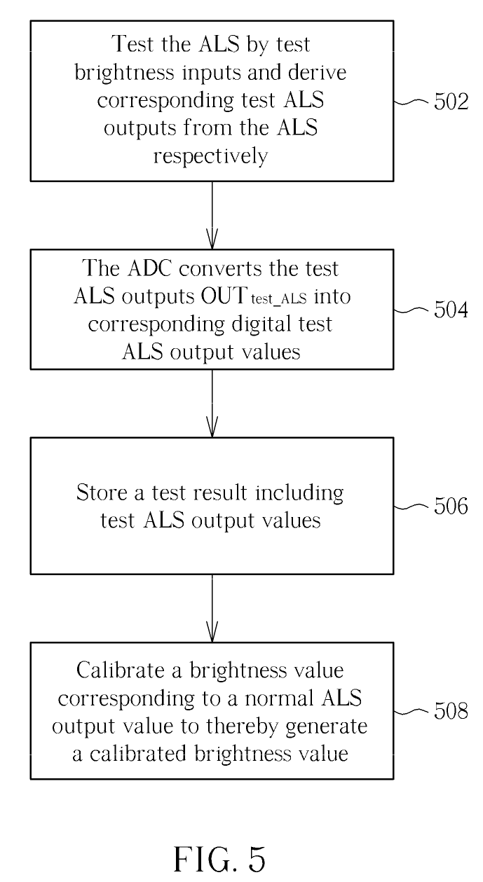

Please refer to FIG. 5 in conjunction with FIG. 1 and FIG. 2. FIG. 5 is a flowchart illustrating operation of the calibration apparatus 100 shown in FIG. 1 and FIG. 2 for calibrating the ALS 199 according to an exemplary embodiment of the present invention. Please note that if the result is substantially the same, the steps are not limited to be executed according to the exact order shown in FIG. 5. The flow includes the following steps:

Step 502: The test device 110 tests the ALS 199 by a plurality of test brightness inputs IN_{test-ALS} (corresponding to digital test brightness values, such as 1 LUX, 100 LUX, 1000 LUX, etc.) and the ALS 199 generates a plurality of test ALS outputs OUT_{test-ALS} respectively, wherein the test ALS outputs OUT_{test-ALS} correspond to the test brightness inputs respectively.

Step 504: The ADC 140 converts the test ALS outputs OUT_{test-ALS} into corresponding digital test ALS output values as 1/W₁, 1/W₁₀₀, 1/W₁₀₀₀, etc.

Step 506: The storage device 120 stores a test result 125. In one embodiment, the storage device 120 is a one-time programmable (OTP) memory within a driver IC 210 shown in FIG. 2, and the calibration apparatus 100 (excluding the test device 100) and the ALS 199 are both disposed within the electronic device 200 (e.g., an LCD device) having the driver IC 210 and the backlight controller 220 included therein, wherein in a further embodiment, the driver IC 210 can further include the backlight controller 220. In addition, the test result 125 may include a plurality of test ALS output values (e.g., 1/W₁, 1/W₁₀₀, 1/W₁₀₀₀, etc.) and a plurality of test brightness values (e.g., 1 LUX, 100 LUX, 1000 LUX, etc.) respectively corresponding to the test brightness inputs IN_{test-ALS}.

Step 508: The calibration device 130 calibrates a brightness value corresponding to a normal ALS output value according to information stored in the test result 125, thereby generating a calibrated brightness value (e.g., the Calibrated LUX shown in FIG. 4).

In Step 508, the calibration device 130 generates the calibrated brightness value corresponding to the normal ALS output value by selecting a suitable range of two test ALS output values. The calibration device 130 then executes a linear-interpolation operation by using the information stored in the test result 125 to derive the calibrated brightness value according to the normal ALS output value, the corresponding two test ALS output values and corresponding two test brightness values. As the linear-interpolation operation is well known to those skilled in the art, further explanation is omitted here for brevity.

After the calibration apparatus 100 generates the calibrated brightness value BV_{c}; the backlight controller 220 receives the calibrated brightness value BV_{c} as a control signal S_{control} to adjust the luminance of the output light brightness of the backlight module 230 within the electronic device (e.g., an LCD device or a portable apparatus having an LCD device) 200.

Please note that as the operation of the calibration apparatus 100 has been detailed in the above paragraphs, a detailed description is not given here for brevity.

In conclusion, the aforementioned embodiments of the present invention provide a calibration apparatus and calibration method thereof for calibrating an ambient light sensor, to eliminate or alleviate the non-linear output characteristic and die-by-die deviation (process variation) of the ambient light sensor by calibrating the output signal of the ambient light sensor to generate a calibrated brightness value.

When the calibration apparatus and calibration method are employed in an electronic device having a backlight controller and a corresponding backlight module, the backlight controller can receive the calibrated brightness value indicative of the accurate ambient light brightness, and then adequately generate a control signal to tune the luminance of the backlight module in accordance with the instant variation of the ambient light brightness. With the implementation of the calibration apparatus of the present invention, the performance of the ambient light brightness detection is greatly improved.

Those skilled in the art will readily observe that numerous modifications and alterations of the device and method may be made while retaining the teachings of the invention.

What is claimed is:

1. A calibration method for calibrating an ambient light sensor (ALS), comprising:
testing the ALS by a plurality of test brightness inputs, and deriving a plurality of test ALS outputs respectively corresponding to the test brightness inputs;
converting at least the test ALS outputs from an analog manner into a digital manner to generate a plurality of test ALS output values respectively;
storing a test result including at least a plurality of test ALS output values respectively corresponding to the test ALS outputs; and
calibrating a brightness value corresponding to a normal ALS output value according to information stored in the test result, thereby generating a calibrated brightness value.

2. The calibration method of claim 1, wherein the test result is stored in a non-volatile memory.

3. The calibration method of claim 2, wherein the non-volatile memory is a one-time programmable (OTP) memory.

4. The calibration method of claim 2, wherein the non-volatile memory is disposed in a driver IC.

5. The calibration method of claim 1, wherein calibrating the brightness value comprises:
determining a plurality of continuous values between the test brightness values in the test result and test ALS output values in the test result by a linear-interpolation operation; and
generating the calibrated brightness value corresponding to the normal ALS output value from the continuous values.

6. The calibration method of claim 1, further comprising:
utilizing the calibrated brightness value to serve as a control signal of a backlight controller.

7. A calibration apparatus for calibrating an ambient light sensor (ALS), comprising:
a test device, for generating a plurality of test brightness inputs to the ALS, wherein the ALS generates a plurality of test ALS outputs in response to the test brightness inputs, respectively;
an analog to digital converter (ADC), for at least converting the test ALS outputs from an analog manner into a digital manner to generate a plurality of test ALS output values respectively;
a storage device, for storing a test result including at least a plurality of test ALS output values; and
a calibration device, coupled to the storage device, for calibrating a brightness value corresponding to a normal ALS output value according to information stored in the test result, thereby generating a calibrated brightness value.

8. The calibration apparatus of claim 7, wherein the storage device is a non-volatile memory.

9. The calibration apparatus of claim 8, wherein the non-volatile memory is a one-time programmable (OTP) memory.

10. The calibration apparatus of claim 7, wherein the storage device is disposed in a driver IC.

11. The calibration apparatus of claim 7, wherein the storage device further stores a plurality of continuous values between the test brightness values in the test result and test ALS output values in the test result that are derived by an linear-interpolation operation; and the calibration device generates the calibrated brightness value corresponding to the normal ALS output value from the continuous values.

12. The calibration apparatus of claim 7, wherein the calibration apparatus further utilizes the calibrated brightness value to serve as a control signal of a backlight controller.

13. The calibration apparatus of claim 7, wherein the ADC receives a normal ALS output value from the ALS and converts the normal ALS output value into a digital manner from an analog manner to generate the normal ALS output value.
